(19) United States
(12) Patent Application Publication
(10) Pub. No.: US 2017/0228789 A1
(43) Pub. Date: Aug. 10, 2017

(54) Formatting Electronic Promotional Material for Mobile Devices

(71) Applicant: Alexander Macgillivray, San Francisco, CA (US)

(72) Inventor: Alexander Macgillivray, San Francisco, CA (US)

(73) Assignee: Google Inc., Mountain View, CA (US)

(21) Appl. No.: 11/555,511

(22) Filed: Nov. 1, 2006

Related U.S. Application Data
(60) Provisional application No. 60/817,601, filed on Jun. 28, 2006.

(51) Int. Cl. G06Q 30/02; G06F 17/30

(52) U.S. Cl. CPC G06Q 30/0267; G06F 17/30569

(57) ABSTRACT

A computer-implemented method of processing content at a mobile communications device may include transmitting from a mobile communication device to a first content provider a request for content, the request for content including at least one of a search query and a request for a specific network-accessible element; receiving in response to the request, responsive content and a substitute electronic promotional item from the first content provider; and transmitting a response to the received substitute electronic promotional item. The first content provider may, in response to the request (a) obtain from a second content provider content that is responsive to the request and an electronic promotional item; (b) identify the electronic promotional item; and (c) replace the identified electronic promotional item with the substitute electronic promotional item.

### CROSS-REFERENCE TO RELATED APPLICATIONS

This application claims the benefit of prior U.S. provisional application 60/817,601, filed Jun. 28, 2006, by Alexander Macgillivray and entitled “Formatting Electronic Promotional Material for Mobile Devices.”

### TECHNICAL FIELD

Formatting electronic promotional material for mobile devices is generally described. In particular, formatting electronic promotional material for efficient presentation in mobile handheld communication and computing devices is described.

### BACKGROUND

The number of Internet and web users has grown significantly, and advertisers have increasingly tapped this market. Advertisers may direct advertising to users who are, for example, searching for online information, reading news online or researching product information online. The proliferation of high-speed, high-capacity broadband connections has fueled media-rich, interactive online advertising. Online users may be presented with video or animated advertising that surrounds the information they are consuming, or that “pops up” or “floats over” the web pages they are browsing.

The number of mobile device users has also grown significantly. People are accessing the Internet from cell phones, smartphones, wireless-enabled personal digital assistants (PDAs) and various other portable communication and computing devices. Many of these devices have smaller screens than, for example, desktop computing devices, from which a large number of online users connect to the Internet. In addition, although data transfer bandwidth of portable communication and computing devices is increasing, it may be lower than, for example, a desktop computing device that is physically connected to a broadband connection.

### SUMMARY

A method of delivering web content to a mobile device may include identifying advertising material included within the web content and optionally replacing it with substitute advertising content.

In some implementations, a computer-implemented method of providing content to a mobile device includes receiving a request for content from a mobile device; retrieving the requested content and an electronic promotional item for presentation with the requested content; replacing the electronic promotional item with a substitute electronic promotional item; and providing the requested content and the substitute electronic promotional item to the mobile device.

The request for content may include at least one of a search query and a request for a specific network-accessible element. The electronic promotional item may be electronic advertising material associated with subject matter of the requested content. The electronic promotional item may be electronic advertising material associated with a keyword included in the request. The substitute electronic promotional item may be formatted for presentation by a mobile device selected from the group consisting of a cellular telephone, a personal digital assistant, and a handheld communication and computing device. The replaced electronic promotional item may not be formatted for presentation by the mobile device.

In some implementations, the computer-implemented method further includes transcoding the requested content from a first format to a second format; and providing the requested content may include providing content that has been transcoded to the second format.

In some implementations, the computer-implemented method further includes identifying the electronic promotional item by searching the requested content for a reference to a known ad server and, upon finding the reference, identifying portions of the requested content that are contiguous with and that include the reference as the electronic promotional item. In some implementations, the computer-implemented method further includes identifying the electronic promotional item by searching the requested content for a link to a domain that is unrelated to a domain associated with the requested content and, upon finding the link, identifying portions of the requested content that are contiguous with and include the link as the electronic promotional item. In some implementations, the computer-implemented method further includes receiving a response to the substitute electronic promotional item from the mobile device.

In some implementations, the computer-implemented method further includes selecting the substitute electronic promotional item by selecting the substitute electronic promotional item from a plurality of candidate substitute electronic promotional items. At least one of the plurality of candidate substitute electronic promotional items may be related to the electronic promotional item by either being directed to a similar product or by being sponsored by the same entity. Selecting the substitute electronic promotional item from the plurality of candidate substitute electronic promotional items may include dynamically bidding candidate substitute electronic promotional items against each other based on parameters selected by respective sponsors of the candidate substitute electronic promotional items.

In some implementations, a system that provides electronic content to a mobile device includes an interface that receives a request for content from a mobile device; a content retrieval module operable to retrieve content responsive to the received request and electronic promotional material for presentation with the retrieved content; and a replacement module for identifying the electronic promotional material and replacing it with substitute electronic promotional material. The system may further include a transcoding module that transcodes the retrieved content from a first format to a second format.

The interface may also transmit to the mobile device the content that is responsive to the received request and the substitute electronic promotional material. The content retrieval module may include a network search engine. The content retrieval module may include a proxy system that couples to a network search engine or content provider on behalf of the mobile device. The request for content may include at least one of a search query and a request for a specific network-accessible element.

In some implementations, a system that transcodes electronic content includes an interface that receives a request for content from a mobile device, wherein the request for content includes at least one of a search query and a request for a specific network-accessible element; a content retrieval module that retrieves content responsive to the received request and electronic promotional material for presentation with the retrieved content; and a means for identifying the electronic promotional material and replacing it with substitute electronic promotional material. The interface may also transmit to the mobile device the content and the substitute electronic promotional material in response to the received request.

In some implementations, a computer-implemented method of processing content at a mobile communications device includes transmitting from a mobile communication device to a first content provider a request for content, where the request for content includes at least one of a search query and a request for a specific network-accessible document; receiving in response to the request, responsive content and a substitute electronic promotional item from the first content provider; and transmitting a response to the received substitute electronic promotional item.

In some implementations, the first content provider may, in response to the request, (a) obtain from a second content provider content that is responsive to the request and an electronic promotional item; (b) identify the electronic promotional item; and (c) replace the identified electronic promotional item with the substitute electronic promotional item.

Transmitting a response to the received substitute electronic promotional item may include transmitting information solicited by the substitute electronic promotional item to the first content provider. In some implementations, the first content provider and the second content provider are the same.

Advantages may include one or more of the following. The substitute advertising content may be suitable for presentation by a mobile device. The substitute advertising content may solicit an appropriate response for a mobile device user. The substitute advertising content may consume a reasonable amount of bandwidth and processing power of a mobile device that receives the advertising content. A user of a mobile device may benefit by receiving advertising content that is appropriate for presentation by the mobile device. A provider may benefit by collecting additional revenue for delivering appropriate content to mobile devices.

The general and specific aspects may be implemented using a system, a method, or a computer program, or any combination of systems, methods, and computer programs. The details of one or more embodiments are set forth in the accompanying drawings and the description below.

### BRIEF DESCRIPTION OF DRAWINGS

These and another aspects will now be described in detail with reference to the following drawings.

FIG. 1. is a block diagram of an example environment in which electronic promotional material (e.g., advertising material) may be identified and replaced with substitute electronic promotional material.

FIG. 2 provides screenshots of example advertising material and substitute advertising material.

FIG. 3 is a flow diagram illustrating example actions that may be taken to identify and replace electronic promotional material.

FIG. 4 is a block diagram of a system that may perform one or more actions illustrated in FIG. 3.

FIG. 5 is a block diagram of example computing devices that may be used to implement the systems and methods described herein.

Like reference symbols in the various drawings indicate like elements.

### DETAILED DESCRIPTION

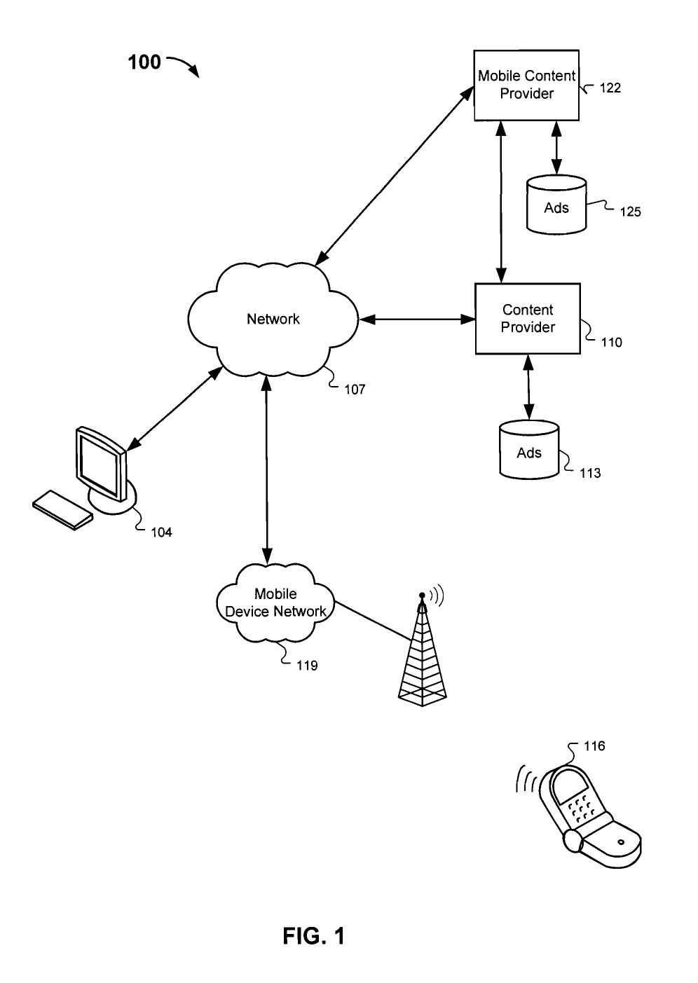

FIG. 1 provides a block diagram of an example environment 100, in which electronic promotional material (e.g., announcements, advertising, reviews, coupons, sweepstakes, etc.—referred to in various places in this description as “advertising material,” which should be understood to broadly include all kinds of electronic promotional material) may be identified and replaced with substitute electronic promotional material before being delivered to a mobile device. Within the example environment 100, various mobile and nonmobile devices may receive various services, such as, for example, voice and data services from various networks. Along with the services, the devices may receive electronic promotional material. Although the voice and data services may be available from both mobile and nonmobile devices, certain services or material may be specifically tailored for either a mobile device or a nonmobile device. (For purposes of illustration, a desktop computing device is used herein as a non-limiting example of a nonmobile device; a wireless PDA and a smartphone are used herein as non-limiting examples of mobile devices.) Components of the example environment 100 may identify electronic promotional material that is tailored for a nonmobile device, and replace it with substitute electronic promotional material that is tailored for a mobile device, before delivery of the electronic promotional material to a mobile device.

In some implementations, graphic-intensive, media-rich data services may be tailored for nonmobile devices, which, on average, may be generally associated with larger display screens, more memory, faster processors and a higher bandwidth connection to the service provider. Content that is tailored for presentation along with media-rich data services may be designed to take full advantage of the large display screens, more memory, faster processor speed and higher bandwidth connections by engaging the user with sound and visual effects. The content may be formatted, for example, as Flash files, or QuickTime movies. The content may be coded with dynamic hypertext mark up language (DHTML) code, JAVA script or Jscript for execution primarily on a nonmobile client machine or the content may be coded to cooperate with the service, such as with active server page protocol.

In some implementations, text or short message based services, or voice services, may be tailored to mobile devices, which, on average, may be generally associated with smaller display screens, less memory, slower processors and a lower bandwidth connection to the service provider. Content that is tailored for presentation by lower bandwidth mobile devices may be optimized for the smaller display screens and lower bandwidth connections, and may engage users less or in different ways.

Along with various services, the devices may receive and respond to electronic promotional items, such as, for example, electronic advertisements (“ads”). In some implementations, sponsors of the ads may be charged for delivery of the ads based on a number of instances of the ad actually being delivered (e.g., a number of “impressions”), or based on a “click-through rate,” or rate at which users “respond” to the ad. Different ads may support different kinds of user “responses” to the ad. For example, a desktop computer user may be able to respond to a media-rich browser-based ad by clicking on the ad to activate an embedded link, playing a optional video, filling out a form (possibly after clicking on a link associated with the ad) or making a purchase. As another example, a wireless PDA user may respond to an ad by clicking on a link, sending an email or text message, or initiating a mobile voice call.

Ads may be formatted differently, based on whether they are primarily directed to mobile or nonmobile devices. For example, ads primarily directed to nonmobile devices may be formatted for display in rectangular frames within a browser page, in “skyscraper” frames along the edge of a browser page, in horizontal “banners” across a page, or as “pop-up” or “pop-under” windows that are separate from the browser window from which they were “activated.” As other examples, ads directed primarily to mobile devices may be formatted as a single line or a small number of lines of text for presentation on a small display screen, as a graphic or short animation file, or as a link to a telephone number that the mobile device can dial upon selection of the link by a user of the mobile device.

In some implementations, a mobile device may access content that was primarily designed to be accessed by nonmobile devices. The content may include one or more electronic promotional items or ads that may also have been primarily designed for access by nonmobile devices. In such implementations, it may be advantageous to replace certain ads or ads. Various components of a system that may perform such a replacement are now described in detail with reference to the example environment 100 that is shown in FIG. 1.

As shown, FIG. 1 includes a nonmobile device 104, such as a desktop computer that can access, via a network 107, various content from one or more content providers, such as a content provider 110. In some implementations, the content may be web content, delivered by hypertext transfer protocol (HTTP), and the content provider 110 may include a web server. For example, the content may include network-accessible elements (e.g., text, graphics, video, programs and other electronic media) from a news service provider, such as www.cnn.com or espn.go.com; the content may include results of a query for information to a search engine such as Google; or the content may include internal company information delivered via the company's intranet.

Along with the content, the content provider 110 may provide advertising material. In some implementations, the advertising material may be related to the content. For example, the advertising material may be matched to a query for information based on specific words in the query by an application such as Google's AdWords. As another example, the advertising material may be matched to content based on subject matter of the content itself by an application such as Google's AdSense. In either example, advertising material may be selected from an advertising database, such as the advertising database 113. Several candidate ads may be matched to particular content, and one or more ads may be ultimately selected based on other parameters, such as parameters selected by the ad sponsor (e.g., a desired maximum ad cost or ad frequency). In some implementations, ads may be “bid” against each other based on the other parameters.

The network 107 may be a private network, internal to a company or organization; the network 107 may be a public network, such as the Internet; or the network 107 may include a combination of public and private networks. Portions of the network 107 may be wired, and other portions may be wireless.

The example environment 100 also includes a mobile device 116, such as a smartphone. The mobile device 116 may also access various voice and data services. Voice services may be provided through a separate mobile device network 119 that, as shown, connects to the network 107. Through the networks 119 and 107, the mobile device 116 may access various data or data services, for example, content from the content provider 110 or content available from a separate mobile content provider 122.

The separate mobile content provider 122 may deliver content specifically to mobile devices. In some implementations, the mobile content provider 122 may act as a proxy or a “transcoder” to access and convert or reformat content from the content provider 110 for presentation by the mobile device 116. For example, the content provider 122 may convert or reformat content in a hypertext markup language (HTML) format from or accessible by the content provider 110 and structured for delivery by HTTP, to content in a wireless mark up language (WML) format, structured for delivery by a wireless access protocol, (WAP).

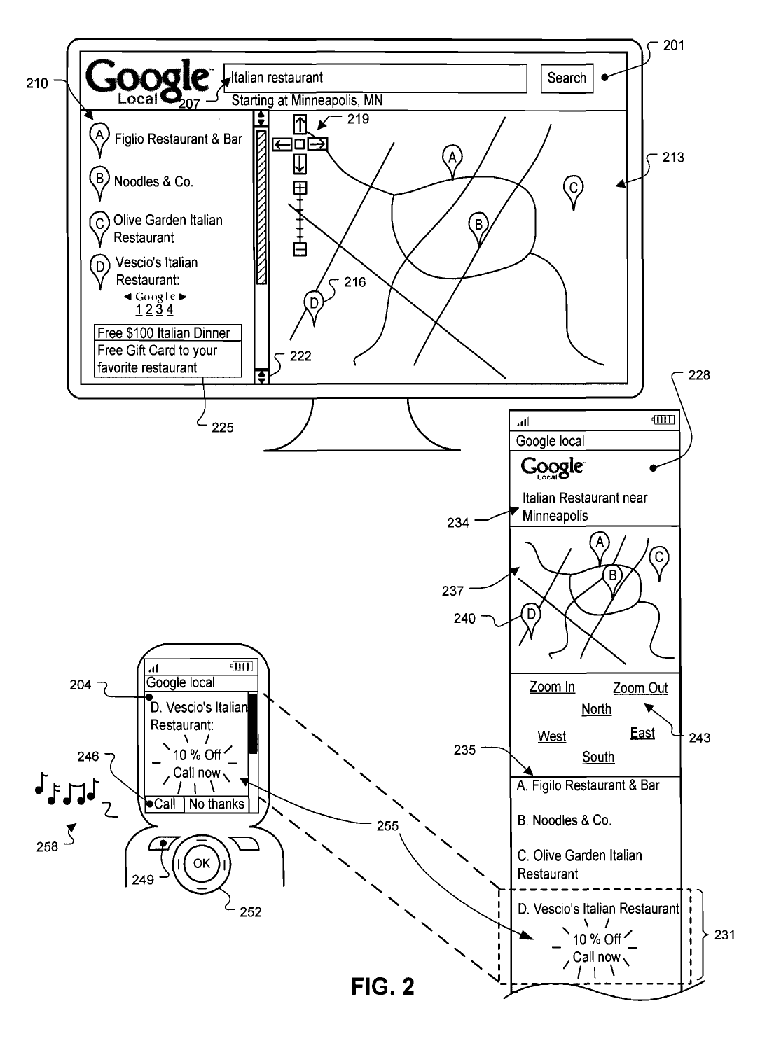

In some implementations, the mobile content provider 122 may deliver mobile ads along with mobile content, for presentation by mobile devices. The mobile ads may be selected from a mobile ads database 125. Although the database 125 is shown in FIG. 1 as separate from the database 113, in some implementations, database 125 and database 113 may be part of the same database. The mobile ads may be identified based on the content provided by the mobile content provider 122. In some implementations, such as those in which the mobile device 116 accesses content and ads from the content provider 110, the mobile content provider 122 may replace ads with substitute ads. For example, the mobile content provider 122 may identify the ads provided by the content provider 110 (possibly in conjunction with the ad database 113) and replace them with substitute ads (possibly from the mobile ads database 125). The substitute ads may be formatted for presentation by a mobile device, whereas the replaced ads may be formatted for presentation by a nonmobile device. The process of identifying ads and optionally replacing them with substitute ads is now described with reference to FIG. 2.

In operation, a user of the mobile device 116 may request content from a content provider 110. The request may be routed via the mobile device network 119 and the network 107 to the mobile content provider 122. The mobile content provider 122 may route the request to the content provider 110, which may retrieve the requested content and may also retrieve an ad or item from the ads database 113. At the content provider 110, the retrieved content and ad may have a format that is appropriate for presentation by the nonmobile device 104, and this content and ad may be routed back to the mobile content provider 122. The mobile content provider 122 may reformat the content for presentation by the mobile device 116 and may further identify the ad and replace it with a substitute ad or promotional item from the ads database 125 The substitute ad may be formatted for presentation by the mobile device 116. The mobile content provider 122 may then transmit the (possibly reformatted) content and the substitute ad to the mobile device 116 via the network 107 and the mobile device network 119.

FIG. 2 provides screenshots of example content and advertising material on a nonmobile device and similar content and substitute advertising material on a mobile device, illustrating how advertising material may be identified and replaced for presentation by a mobile device. As shown, the first example screenshot 201 corresponds to a nonmobile device, such as the nonmobile device 104 that is shown in FIG. 1; the second screenshot 204 corresponds to a mobile device, such as the mobile device 116. As described above, the nonmobile device 104 may be associated with a larger screen, more processing power and a greater-bandwidth network connection; the mobile device 116 may be associated with a smaller screen, less processing power, and a lower-bandwidth network connection.

As shown, the example content 201 is responsive to a query for information (e.g., a query for the location of Italian restaurants near Minneapolis). The content includes the original search query 207, a list of results 210 that meet the original search query 207, a map 213, and various markers (e.g., marker 216) on the map 213 corresponding to the list of results 210. Various controls (e.g., controls 219 or 222) allow a user of the nonmobile device 104 to manipulate the content, such as, for example, by navigating through the list of results 210, selecting individual markers, panning or zooming in on detail on the map 213, etc.

As shown, the content 201 also includes advertising material 225. In some implementations, the advertising material 225 may include a link that, upon selection, takes a user to another site. In some implementations, the advertising material 225 may be graphic-intensive, media-rich advertising, such as, for example, flash-based advertising that presents video and sound media.

In some implementations, the example content 201 may also be substantially available as content 228 from a mobile device. The screenshot 204 illustrates a portion 231 of the content 228 as it may appear on a mobile device, such as, the mobile device 116. The content may be “scrollable” within discrete “pages.” As shown, the content 204 represents a portion 231 of the scrollable content 228 that may be displayed on the mobile device at one time. As shown, the content 228 is also responsive to the example query for information described above (a query for location of Italian restaurants near Minneapolis). The content 228 includes the original search query 234 itself, a list of results 235 that meet the original search query 234, a map 237, and various markers (e.g., marker 240) on the map 237 corresponding to the list of results 235. The user of the mobile device 116 may use various controls, such as hyperlinks (e.g., hyperlink 243) or control boxes (e.g., control box 246), to navigate through the list of search results 235, pan or zoom within the map 237, etc. To activate the various controls (e.g., controls 243 or 246), the user may employ various keys (e.g., key 249), buttons or other means of input (e.g., voice activation; motion sensors; position sensors that sense, e.g., roll, pitch or yaw). For example, the user may employ a directional navigation button 252 to select one of the various map control links (e.g., link 243), or a button 249 to select a “soft command” 246 displayed on the screen.

The content 228 may also include an electronic promotional item 255, such as an ad, that solicits a response form the mobile device user. As shown, the ad is associated with a particular entry from the list of results 235 (e.g., “Vescio's Italian Restaurant”). The ad 255 may include text, graphics or sound to attract the user's attention. For example, the ad may include scrolling or flashing text or graphics that appear in a different color from the color of other displayed text, or that change color. The text or graphic may be associated with a sound 258 that is played when the ad is “in focus,” or displayed in the viewable portion 231 of the page 228. The ad 255 may solicit action that is appropriate for a mobile device user. For example, the ad 255 may provide the user with a soft command 246 that, upon activation by a user of a corresponding key 249 or other input, causes the mobile device to dial a number associated with the ad 255. Dialing the number may allow the mobile device user to call a restaurant (e.g., “Vescio's Italian Restaurant”) to make a reservation. As another example, an ad may solicit a vote from a user, possibly in response to a survey that may be related to other content presented by the mobile device. Other responses that are appropriate for mobile device users may also be solicited.

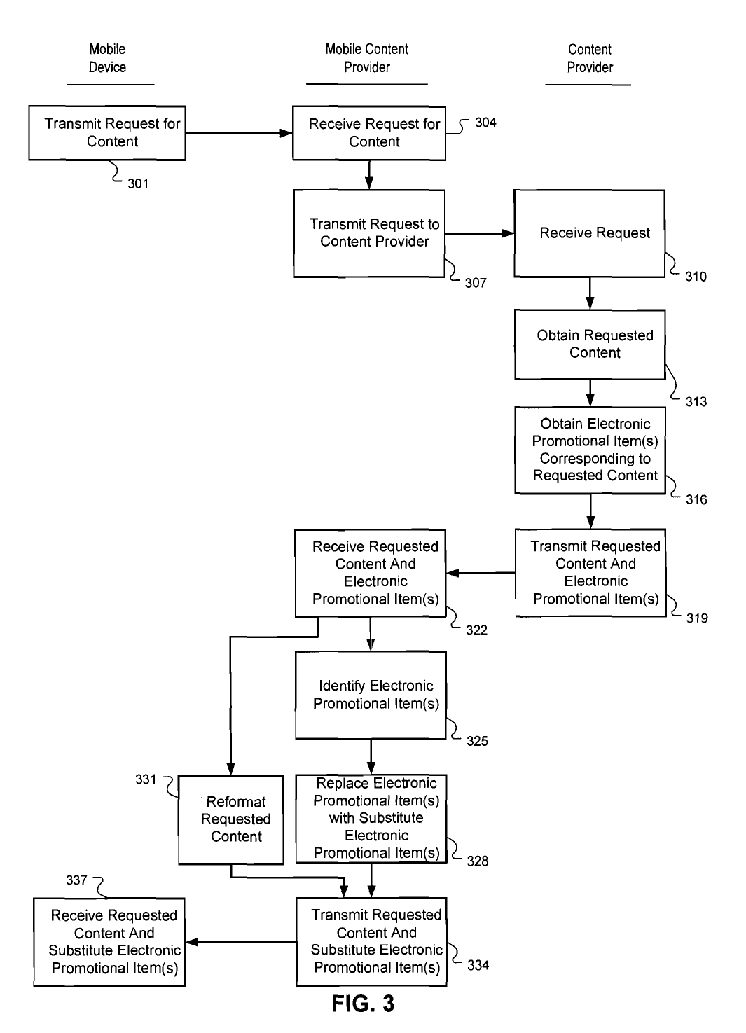

In some implementations, the ad may be a substitute ad that is presented to replace an ad corresponding to content for a nonmobile device. That is, a content provider, such as the mobile content provider 122 that is shown in FIG. 1, may identify ads associated with content from the content provider 110 and replace them with substitute ads that may be more appropriate of presentation by a mobile device. The process by which an ad may be identified and replaced with a substitute ad is now described in greater detail with reference to FIG. 3.

To summarize the example shown in FIG. 2, a mobile device may transmit to a content provider a request for information (e.g., a request for Italian restaurants in Minneapolis) (request not shown in FIG. 2). The content provider may respond to the request (e.g., with a listing of Italian restaurants in Minneapolis) and may also identify an ad that corresponds to the requested information. Had the request been received from a nonmobile device, the responsive information and ad may appear as shown in the screenshot 201. A mobile content provider (shown in FIG. 2) may reformat for presentation by a mobile device the content, and identify and replace the ad with a substitute ad. The reformatted content and substitute ad may appear as shown in the screenshot 228, of which portion 204 is a part. As shown, the ad 225 that would have been displayed on a nonmobile device has been replaced by the ad 255, which is suitable for presentation by a mobile device.

FIG. 3 is a flow diagram illustrating example actions that may be taken to identify electronic promotional material within other content, replace the electronic promotional material with substitute electronic promotional material, and deliver the content and substitute electronic promotional material to a mobile device. For purposes of illustration, the actions are indicating as occurring at a mobile device, mobile content provider and a content provider. However, the actions or similar actions could also be carried out by fewer devices or sites or with a different arrangement of devices or sites.

As shown, a user of a mobile device may transmit (301) to a mobile content provider a request for content. For example, a user of the mobile device 116 may transmit (301) a query for information about Italian restaurants in the Minneapolis area to a mobile content provider 122. In some implementations, the user-entered query may include location information corresponding to the query; in some implementations, location-pinpointing technology within the mobile device 116 or corresponding mobile device network 119 may provide such location information to the mobile device 116.

A mobile content provider receives (304) the request. For example, the mobile content provider 122 may receive a request for content from the mobile device 116 via the network 107 and mobile device network 119. In some implementations (as illustrated in FIG. 3), the mobile content provider 122 may provide proxy and transcoding functionality to allow mobile devices to access content that may not be specifically formatted for presentation by mobile devices. For example, the mobile content provider may retrieve content from another content provider 110 in one format (e.g., HTML format for delivery via HTTP), transcode the content into another format (e.g., WML format for delivery via WAP), and deliver the transcoded content to a mobile device. In some implementations (not shown in FIG. 3), the mobile content provider 122 may maintain or access its own body of content that is specifically formatted for presentation via a mobile device. For example, the mobile content provider 122 may provide data services tailored specifically for mobile devices, such as, for example, data services for a traffic congestion application, such as Zipdash. As another example, the mobile content provider 122 may provide a substantial “mirror” of data content available from the content provider 110. More particularly, a news provider may provide multi media-rich content for nonmobile devices from content provider 110, and the same news provider may maintain separate but substantively similar content consisting of primarily text and small images for mobile devices from mobile content provider 122.

In the proxy and transcoding implementations described above, the mobile content provider transmits (307) the request to another content provider. For example, the mobile content provider 122 transmits (307) the request (e.g., a query for Italian restaurants in Minneapolis) to the content provider 110. The mobile content provider 122 may transmit (307) the request to the content provider 110 via the network 107, for example, using standard protocols; or the mobile content provider 122 may transmit (307) the request to the content provider 110 via a substantially direct or private connection.

The content provider receives (310) the request. For example, the content provider 110 receives (310) the request from the mobile content provider 122. In response to receiving (310) the request, the content provider obtains (313) the requested content. Referring to FIG. 2, the content provider 110 may obtain content that, if displayed on a nonmobile device such as the device 104, would appear as the list of results 210 and the map 213.

In some implementations, the content provider 110 maintains a database of content (not shown) and obtains the requested content from the database. In some implementations, the content includes a search engine that maintains an index (not shown) of content inside and outside a content provider 110, and the content provider 110 retrieves (313) the requested content from inside or outside the content provider 110 based on contents of the index. The index may be regularly updated, for example, by automated web crawlers or spiders, and if the requested content is not currently indexed, the content provider 110 may dynamically locate it.

Upon obtaining (313) the requested content, the content provider obtains (316) one or more electronic promotional items to provide with the content. For example, the content provider 110 may obtain (316) one or more ads from the ad database 113. More particularly, as described above, the content provider 110, or a separate ad provider (not shown), may identify various “candidate ads.” The candidate ads may correspond to the requested content, to a query associated with the requested content, or to some other parameter associated with a user or device requesting the content. For example, candidate ads may be selected by certain words associated with the initial query (e.g., “Italian restaurants”); by certain words associated with one or more results (“Olive Garden” or “Vescios”); by some parameter associated with the requesting device (e.g., mobile device model, mobile network, location, current user account associated with the request, etc.); or by some other parameter (e.g., based on random selection of ads; rotating selection; selection based on time of day or day of week). From the candidate ads, the content provider 110 or ad provider may select one or more ads to deliver with the requested content. The selection may further be based on parameters set by an ad sponsor, such as maximum ad cost or frequency. In some implementations, the final selection may result from an effective dynamic electronic “auction” where two or more ads are “bid” against each other. Referring to FIG. 2, the content provider 110 may obtain the ad 225.

Once the content provider finally selects and obtains (316) one or more electronic promotional items, it transmits (319) both the requested content and the one or more electronic promotional items to the mobile content provider. For example, the content provider 110 may transmit (319) the requested content and the obtained ad(s) to the mobile content provider 122, via the network 107 or via a direct connection.

The mobile content provider receives (322) the requested content and one or more electronic promotional items. For example, the mobile content provider 122 receives the requested content and the one or more corresponding ads. Referring to FIG. 2, the requested content and one or more corresponding ads may include the list of results 210, the map 213 and the ad 225.

The mobile content provider identifies (325) the one or more electronic promotional items. For example, referring to FIG. 2, the mobile content provider 122 may identify (325) the ad 225. The mobile content provider 110 may identify the ad 225 in numerous ways. In some implementations, portions of the content and the ad 225 may be coded in various formats common to networks, such as, for example, HTML, extensible HTML (XHTML), extensible markup language (XML), JAVA script, or other appropriate formats; identifying the ad 225 may include parsing the code and/or searching the code for particular elements. For example, the mobile content provider 122 may search for references to known ad servers (e.g., “doubleclick” or “googlesyndication”) and may identify parsed sections that contain the references to the known ad servers as ads. As another example, the mobile content provider 122 may search for links that, if selected, would redirect a user to a different domain, unrelated to a domain corresponding to the content; upon finding such a link, the mobile content provider 122 may identify a section of code that contains the link as an ad. As another example, the mobile content provider 122 may search for keywords, such as, for example, “advertising” or “ad”; upon finding such a keyword, the mobile content provider 122 may identify a section of code that contains the keyword as an ad.

Upon identifying (325) the one or more electronic promotional items, the mobile content provider replaces (328) the one or more electronic promotional items with one or more substitute electronic promotional items. For example, the mobile content provider 122 may replace ads originally selected from the ads database 113 by the content provider 110 with substitute ads from the ads database 125. In some implementations, a substitute ad may be related to the replaced ad. That is, the substitute ad may be provided by the same ad sponsor as the replaced ad, and the substitute ad may be for the same product or service as the replaced ad; however, the substitute ads may be formatted for presentation by a mobile device, whereas the replaced ads may be formatted for presentation by a nonmobile device. In some implementations, a substitute ad may be unrelated to the replaced ad. For example, the substitute ad may be provided by a different ad sponsor than the replaced ad, or the substitute ad may be for a different product or service than the replaced ad. The substitute ad may be selected in a separate “auction” of mobile device ads, similar to that described above. Referring to FIG. 2, the ad 225 displayed on the nonmobile device has been replaced with the substitute ad 255 for presentation by the mobile device.

In addition to replacing (328) one or more electronic promotional items with one or more substitute electronic promotional items, the mobile content provider may reformat (331) the requested content. As an example, the requested content may be in a format such as HTML, and the mobile content provider may transcode it to have a format such as WML. Transcoding or reformatting (331) may involve conversions or translations from or to other formats. In general, if necessary, the mobile content provider 122 may convert content from a format appropriate for presentation by a nonmobile device to a format appropriate for presentation by a mobile device. Referring to FIG. 2, the content 201 has a first format for presentation by a nonmobile device, such as the nonmobile device 104, and this content 201 is transcoded to have a second format 228 for presentation by a mobile device such at the mobile device 116.

Upon replacing (328) electronic promotional item(s) with substitute electronic promotional item(s), and optionally reformatting (331) requested content, the mobile content provider transmits (334) the (reformatted) requested content and the substitute electronic promotional item(s) to the mobile device. For example, the mobile content provider 122 may transmit the (reformatted) requested content and substitute ad to the mobile device 116 via the network 107 and mobile device network 119.

The mobile device receives (337) the requested content and one or more substitute electronic promotional items, and subsequently presents them in the mobile device. For example, referring to FIG. 2, the mobile device (e.g., mobile device 116) receives the content 228, including the ad 255, and presents it (displays images and text, plays video, outputs sounds, etc.) on the mobile device.

The transmission (334)/reception (337) process may involve a single, continuous transfer of data; or the transmission (334)/reception (337) process may involve a series of discrete transfers of data. For example, in the case of a single continuous transfer, all of the content 228, including the original query 234, the initial map 237, the controls 243, the list of results 235 and the ad 255 may be transferred to the mobile device, stored in memory on the mobile device, and presented from memory as appropriate. As another example, only portions of the content 228 may be transferred to the mobile device at any given time. The size of the portions transferred may depend on an amount of content that can be displayed at a given time on the mobile device, or an amount of memory included in the mobile device or on some other parameter. More particularly, referring again to FIG. 2, the original query 234, the initial map 237 and the map controls 243 may be transferred in one discrete transfer. Subsequently, a portion of the list of results 235 may be transferred. Subsequently, the portion 231, including the ad 255, may be transferred. Which content is transferred may depend on user input, such as, for example, user input from the navigation button 252 or selection key 249 as the user scrolls through the content 228.

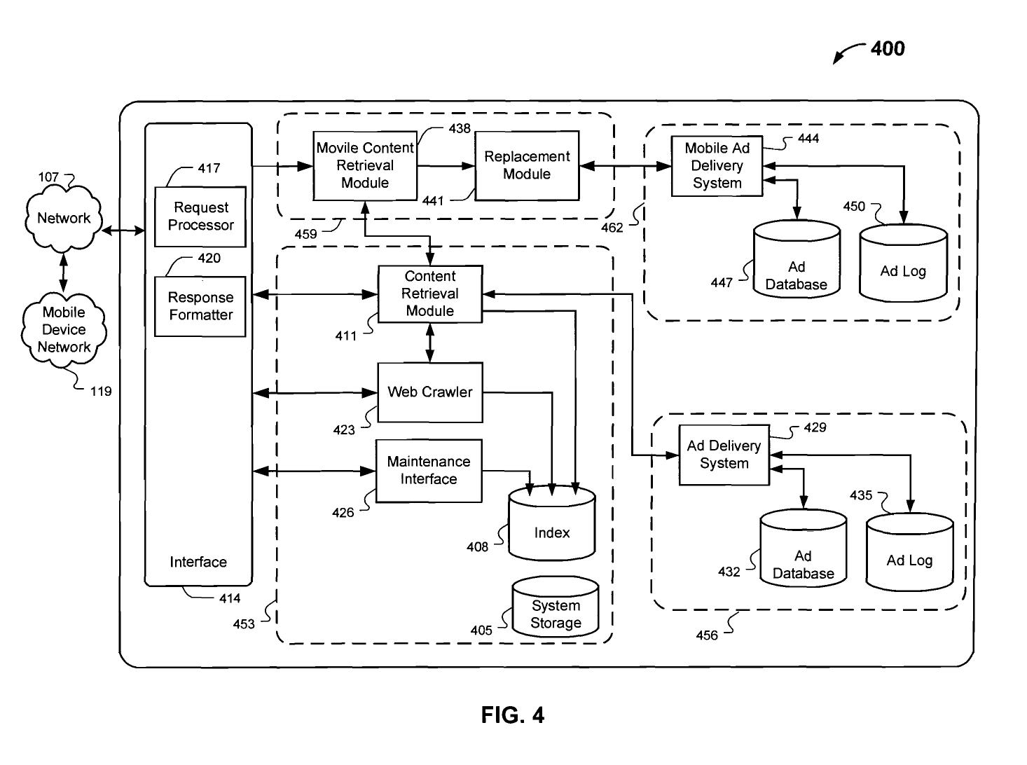

FIG. 4 is a block diagram of a system 400 that may be used to receive a request for content from a mobile device; obtain content responsive to the received request and electronic promotional material that is associated with the retrieved content; identify the electronic promotional material and replace it with substitute electronic promotional material; and transmit the responsive content and the substitute electronic promotional material to the mobile device. In some implementations, portions of the system 400 may be included in a mobile content provider, such as the mobile content provider 122. In some implementations, the system 400 may perform one or more of the example actions described with reference to FIG. 3.

The system 400 may store or index content that users of mobile or nonmobile devices may access. For example, the system may internally store content in a system storage device 405. The system 400 may also index content in an index database 408. The indexed content may be content that is stored in the system storage device 405 or that is stored outside of the system 400. As shown, the system 400 includes a content retrieval module 411 (e.g., a search engine) that accepts requests for content from users of mobile or nonmobile devices and retrieves responsive content, for example from the system storage or from sources external to the system 400, based on entries in the index database 408.

Users may access the content retrieval module 411 via an interface 414, which is shown as connected to the network 107. A user of a nonmobile device, such as, for example, the computing device 104 (see FIG. 1), may access the content retrieval module 411 to retrieve particular content by sending a request to the content retrieval module 411 via the network 107 and the interface 414. Similarly, a user of a mobile device, such as, for example, the mobile device 116, may access the content retrieval module 411 to retrieve particular content by sending a request to the content retrieval module 411 via the networks 119 and 107 and the interface 414. In some implementations, the mobile device network 119 may directly connect to the system 400 (direct connection not shown in FIG. 4).

As shown, the interface 414 includes a request processor 417 and a response formatter 420. The interface may employ the request processor 417 to format for internal use requests received from mobile or nonmobile devices. For example, the request processor 417 may parse requests and reformat them from HTML, WML or text format, to search terms or strings that are compatible with the content retrieval module 411. The interface 414 may employ the response formatter 420 to format content that is responsive to received requests. The response formatter 420 may, for example, format responsive content and ads in a format like HTML, XML, WML, or some other suitable format, depending on the requesting device. The response formatter 420 may work in conjunction with the interface 414, or it may be part of the interface 414, as shown.

Information in the index database 408 may be gathered by an automated information gatherer, such as, for example, a web crawler 423 or a spider. The web crawler 423 may, for example, continuously or almost continuously index new information from sources connected to the network 107. The web crawler 423 may also retrieve content in response to a search query (e.g., content external to the system). Some information that is indexed may also be stored (cached) in the system storage 405.

In addition to being indexed in the index database 408 or added to the system storage 405, information may be manually loaded in (or retrieved from) the index database 408 or system storage 405 through a maintenance interface 426. For example, the maintenance interface 426 may allow an administrator of the system 400 to manually add bulk data to the index database 408 or to the system storage 405.

The system 400 further includes an ad delivery system 429 along with an ad database 432 and an ad log 435. The ad delivery system 429 may receive query requests and other input from the interface 414, via the content retrieval module 411 or directly (direct connection not shown). In some implementations, the ad delivery system 429 may select an ad from the ad database 432 to deliver in conjunction with other content, such as, for example, a response to a query. Referring to FIG. 2, the system 400 may select the ad 225 to deliver to a nonmobile device along with the content 201. The ad delivery system 429 may select one or more ads in the manner described above with reference to FIGS. 1 and 3. Delivery of particular ads may be logged in the ad log 435. In addition, some ads may solicit a response from the user of a device to which the ad is delivered, and any such responses to ads may be directed back to the system 400 and logged in the ad log 435. The contents of the ad log 435 may be subsequently used to bill sponsors of such ads or log various statistics related to ads or to their determined effectiveness.

The system 400 also includes a mobile content retrieval module 438. In some implementations, the mobile content retrieval module 438 functions in a manner similar to the content retrieval module 411 but primarily processes content that may be formatted for presentation by mobile devices. For example, the mobile content retrieval module 438 may receive requests for mobile content from mobile devices, via the networks 119 and 107 and the interface 414; obtain content that is responsive to the requests; and transmit the responsive content back to the requesting device. The mobile content retrieval module 438 may be coupled to a separate index, storage device, web crawler and maintenance interface (not shown in FIG. 4). In some implementations, as shown in FIG. 4, the mobile content retrieval module 438 functions as a proxy or transcoder for accessing content that is accessible by, and possibly formatted for, nonmobile devices. For example, as shown, the mobile content retrieval module 438 is coupled to the content retrieval module 411 and may transcode for delivery to a mobile device content that is retrieved by the content retrieval module 411. More particularly, the mobile content retrieval module 438 may receive a request from a mobile device, via the mobile device network 119, network 107 and interface 414 and transmit the request to the content retrieval module 411. The content retrieval module 411 may obtain content that is responsive to the request (e.g., in HTML format) and transmit the content to the mobile content retrieval module 438. The mobile content retrieval module 438 may transcode the content to a format suitable for presentation by the mobile device (e.g., WML).

As described above, the content retrieved by the content retrieval module 411 may be delivered with one or more ads provided by the ad delivery system 429. The mobile content retrieval module 438 may optionally replace these ads. More particularly, the mobile content retrieval module 438 may employ a replacement module 441 and a mobile ad delivery system 444 to identify an ad and replace it with a substitute ad.

The mobile ad delivery system 444 may be arranged in a structure and function that is similar to the ad delivery system 429. That is, the mobile ad delivery system 444 may select ads from the ad database 447 in the manner described above, and log various parameters associated with the ad in an ad log 450. Referring to FIG. 2, the system 400 may select the ad 255 as a substitute ad for the originally identified ad 225.

The system 400 shown in FIG. 4 is merely an example, and a system that identifies electronic promotional items and replaces them with substitute electronic promotional items may take other forms. In particular, the system 400 may be divided into separate systems to allow for scalability, data integrity or data security; or the system 400 may be divided into separate subsystems, each of which is provided by a different company or physical system. For example, content retrieval module 411, web crawler 423, maintenance interface 426, index 408 and system storage 405 may comprise a standalone system 453 that, in conjunction with the interface 414, provides search engine functionality (e.g., Google systems). Similarly, the ad delivery system 429, ad database 432 and ad log 435 may comprise a standalone ad delivery system 456 (e.g., Google AdWords, or AdSense ad servers), which may provide ads to a search engine or other content provider. Likewise, the mobile content retrieval module 438 may be part of a standalone transcoder 459 that may also include the replacement module 441 for replacing ads with substitute ads. The substitute ads may be provided by a second, standalone ad provider 462. In some implementations, the ad providers 456 and 462 may be part of the same system.

The system 400 may be connected to other networks (not shown), such as, for example, an internal company network or a local wireless communication network. The interface may be distributed and may include other interfaces (not shown) that allow various components to exchange, transmit or receive data. The index and/or storage may be local to the system 400 or external to the system and may also be distributed across various physical devices.

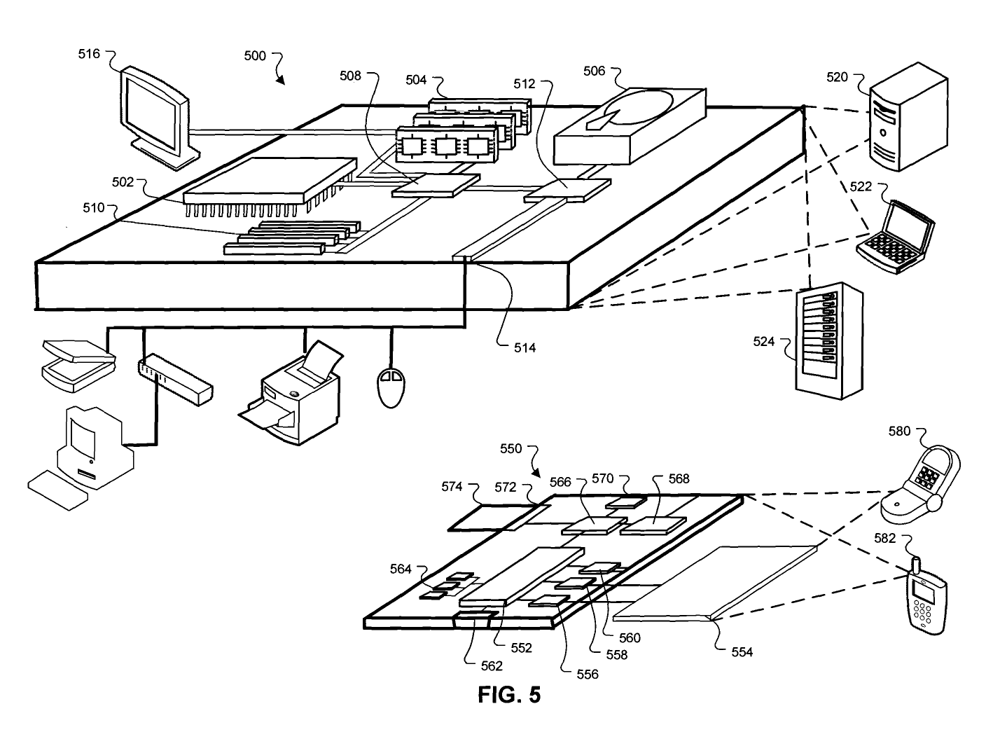

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of duties is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provided as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Embodiments may be implemented, at least in part, in hardware or software or in any combination thereof. Hardware may include, for example, analog, digital or mixed-signal circuitry, including discrete components, integrated circuits (ICs), or application-specific ICs (ASICs). Embodiments may also be implemented, in whole or in part, in software or firmware, which may cooperate with hardware. Processors for executing instructions may retrieve instructions from a data storage medium, such as EPROM, EEPROM, NVRAM, ROM, RAM, a CD-ROM, a HDD, and the like. Computer program products may include storage media that contain program instructions for implementing embodiments described herein.

A number of embodiments have been described. Nevertheless, it will be understood that various modifications may be made without departing from the spirit and scope of this disclosure. Accordingly, other embodiments are within the scope of the following claims.

1. A computer-implemented method comprising:
receiving, at a computer server system and from a mobile device, a request for content;
identifying, using the computer server system, the requested content and an electronic promotional item for presentation with the requested content;
determining that the electronic promotional item that is retrieved for presentation with the requested content is formatted for presentation by non-mobile devices;
responsive to determining the electronic promotional item retrieved for presentation with the requested content is formatted for presentation by non-mobile devices, selecting, from a database that includes a plurality of electronic promotional items formatted for presentation by a mobile device, a substitute electronic promotional item that is formatted for presentation by mobile devices based on one or more parameters associated with the mobile device requesting the content;
identifying a first portion and a second portion of the requested content based on the substitute electronic promotional item;
providing, from the computer server system and to the mobile device, the first portion of the reformatted requested content and the substitute electronic promotional item for presentation;
receiving, at the computer server system from the mobile device, a request for the second portion of the requested content consequent to providing the first portion of the requested content; and
providing, from the computer server system and to the mobile device, the second portion of the requested content consequent to receiving the request for the second portion.

2. The computer-implemented method of claim 1, wherein the request for content comprises at least one of a search query and a request for a specific network-accessible element.

3. The computer-implemented method of claim 1, wherein the electronic promotional item is electronic advertising material associated with subject matter of the requested content.

4. The computer-implemented method of claim 1, wherein the electronic promotional item is electronic advertising material associated with a keyword included in the request.

5. The computer-implemented method of claim 1, wherein the mobile device comprises a mobile device selected from the group consisting of a cellular telephone, a personal digital assistant, and a handheld communication and computing device.

6. (canceled)

7. (canceled)

8. The computer-implemented method of claim 1, further comprising identifying the electronic promotional item by searching the requested content for a reference to a known ad server and, upon finding the reference, identifying portions of the requested content that are contiguous with and include the reference as the electronic promotional item.

9. The computer-implemented method of claim 1, further comprising identifying the electronic promotional item by searching the requested content for a link to a domain that is unrelated to a domain associated with the requested content and, upon finding the link, identifying portions of the requested content that are contiguous with and include the link as the electronic promotional item.

10. (canceled)

11. (canceled)

12. The computer-implemented method of claim 1, wherein selecting the substitute electronic promotional item from the plurality of candidate substitute electronic promotional items comprises dynamically bidding candidate substitute electronic promotional items against each other based on parameters selected by respective sponsors of the candidate substitute electronic promotional items.

13. The computer-implemented method of claim 1, further comprising receiving a response to the substitute electronic promotional item from the mobile device.

14. A system comprising:
an interface operable on one or more processors of a computer system that receives, from a mobile device, a request for content;
a content retrieval module operable on the one or more processors to identify content responsive to the received request and electronic promotional material for presentation with the retrieved content; and
a replacement module on the one or more processors for:
identifying the electronic promotional material;
determining that the electronic promotional item that is identified for presentation with the retrieved content is formatted for presentation by non-mobile devices; and
responsive to determining the electronic promotional item that is retrieved for presentation with the retrieved content is formatted for presentation by non-mobile devices, selecting, from a database that includes a plurality of electronic promotional items formatted for presentation by a mobile device, a substitute electronic promotional item that is formatted for presentation by mobile devices based on one or more parameters associated with the mobile device requesting the content;
identifying a first portion and a second portion of the requested content based on the substitute electronic promotional item;
providing, from the computer server system and to the mobile device, the first portion of the reformatted requested content and the substitute electronic promotional item for presentation;
receiving, at the computer server system from the mobile device, a request for the second portion of the requested content consequent to providing the first portion of the requested content; and
providing, from the computer server system and to the mobile device, the second portion of the requested content consequent to receiving the request for the second portion.

15. The system of claim 14, wherein the content retrieval module comprises a network search engine.

16. The system of claim 14, wherein the request for content comprises at least one of a search query and a request for a specific network-accessible element.

17. The system of claim 14, wherein the content retrieval module comprises a proxy system that couples to a network search engine or content provider on behalf of the mobile device.

18. (canceled)

19. A system comprising:
an interface, operable on one or more processors of a computer system, that receives, from a mobile device, a request for content, the request for content comprising at least one of a search query and a request for a specific network-accessible element;
a content retrieval module operable on the one or more processors that retrieves content responsive to the received request and electronic promotional material for presentation with the retrieved content;
one or more processors configured to determine that the electronic promotional material that is retrieved for presentation with the retrieved content is formatted for presentation by non-mobile devices; and
means for identifying, responsive to determining the electronic promotional item that is retrieved for presentation with the electronic content is formatted for presentation by non-mobile devices, substitute electronic promotional material that is formatted for presentation by mobile devices and selected from a database of electronic promotional material formatted for presentation by mobile devices based on one or more parameters associated with the mobile device requesting the content; and
the one or more processors further configured to
identify a first portion and a second portion of the retrieved content based on the substitute electronic promotional material;
provide, the first portion of the reformatted retrieved content and the substitute electronic material for presentation;
receive, from the mobile device via the interface, a request for a second portion of the retrieved content consequent to providing the first portion of the retrieved content; and
provide, to the mobile device, the second portion of the retrieved content consequent to receiving the request for the second portion.

20. A computer-implemented method comprising:
transmitting from a mobile communication device to a content provider a request for content, the request for content comprising at least one of a search query and a request for a specific network-accessible element;
receiving at the mobile communication device in response to the request, a first portion of responsive content formatted for display with a substitute electronic promotional item selected for mobile devices and the substitute electronic promotional item selected for mobile devices from the content provider based on one or more parameters associated with the mobile communication device;
displaying, by the mobile communication device, responsive to receiving the first portion of responsive content and the substitute electronic promotional content, the first portion of responsive content with the substitute electronic promotional content;
receiving an input to the mobile communication device associated with the first portion of responsive content;
transmitting, from the mobile communication device to the content provider a second request for a second portion of responsive content responsive to the input; and
displaying, by the mobile communication device, responsive to receiving the second portion of responsive content, the second portion of responsive content with the substitute electronic promotional content.

21. The computer-implemented method of claim 20, further comprising transmitting a response to the received substitute electronic promotional item, the response comprising information solicited by the substitute electronic promotional item to the content provider.

22. (canceled)

23. (canceled)
